(19) United States
(12) Patent Application Publication
(10) Pub. No.: US 2015/0038668 A1
(43) Pub. Date: Feb. 5, 2015

(54) Branched Polyesters Based On Citric Acid, Their Preparation And Use

(71) Applicant: BASF SE, Ludwigshafen (DE)

(72) Inventors: Dejan Djuric, Mannheim (DE); Monika Haberecht, Ludwigshafen (DE); Karl Kolter, Limburgerhof (DE); Bernd Bruchmann, Freinsheim (DE)

(21) Appl. No.: 14/499,528

(22) Filed: Sep. 29, 2014

Related U.S. Application Data
(63) Continuation of application No. 13/221,245, filed on Aug. 30, 2011.
(60) Provisional application No. 61/378,404, filed on Aug. 31, 2010.

(51) Int. Cl. C08G 63/133

(52) U.S. Cl. CPC C08G 63/133
USPC 528/296

(57) ABSTRACT

Branched polyesters obtained by polycondensation of citric acid with at least one poly-alcohol having at least two hydroxyl groups and, if desired, further polycarboxylic acid components, the molar ratio of citric acid to polyalcohol being 2.4:1 to 1:3.

### CROSS-REFERENCE TO RELATED APPLICATIONS

This application is a continuation of U.S application Ser. No. 13/221,245, filed Aug. 30, 2011, which claims the benefit of U.S. Provisional Application Ser. No. 61/378,404, filed Aug. 31, 2010, the disclosures of which are incorporated herein by reference in their entireties.

### BACKGROUND

Numerous drugs are of very low solubility in water and consequently cannot be absorbed from the gastrointestinal tract. The consequence is a very low bioavailability. With drugs possessing a basic or acidic group, corresponding salts can be formed by reaction with acids or alkalis, and in some cases the salts have better solubilities. For this purpose it is common to use low molecular weight acids or alkalis. The commonest acids are as follows: hydro-chloric acid, sulfuric acid, methanesulfonic acid, acetic acid, citric acid, tartaric acid, fumaric acid, maleic acid, malonic acid, succinic acid, phosphoric acid. Bases used include NaOH, KOH, L-lysine, L-arginine, triethanolamine or diethylamine.

For many drugs, however, even the salts with these low molecular weight compounds are of low solubility in water. Frequently there is hardly any difference between the solubility of the drug acid or drug base, and that of a salt with the stated compounds. The cause of this poor solubility is usually that the salt forms a highly stable crystal lattice which is in a favorable state energetically, meaning that its tendency to go into solution is low. If, additionally, the energy gain through hydration is low, the solubility is lowered further. Moreover, numerous active ingredients are notable for a pronounced lipophilicity, which further lowers the water solubility of their salts.

Salts of drugs with polymeric acids or bases have already been produced to date in principle, but using polymers which were not soluble over a wide pH range—and especially not in the physiologically significant range of pH 1-8—or which in solution, as acid, base or salt, had a high viscosity. If polymers are used which are insoluble at acidic pH values—as is the case with polymers resistant to gastric juice—there is no dissolution of the drug; instead, the polymer is precipitated. This prevents or at least greatly slows the release of active ingredient. The result is a preparation which is resistant to gastric juice and which lowers the bioavailability, since on the one hand there can be no absorption in the stomach and on the other hand the preparation has to dissolve only in the small intestine, at neutral pH values, meaning that release takes place at a relatively late stage and that the entire surface area of the small intestine is no longer available for absorption.

Where the polymers have a high viscosity in aqueous solution, the release of active ingredient from a solid presentation form such as a tablet, for example, is likewise delayed. On dissolution of the salt, a gel or highly viscous solution is formed on the surface of the tablet and in the cavities, hindering further penetration of water into the tablet core and slowing disintegration. These effects, and also the reduced diffusion coefficients of the drug molecules through areas with high viscosity, delay the release of the drug. This possibility for delayed release is exploited in the production of slow-release matrix forms with polymers of high viscosity such as, for example, alginates, xanthan, hydroxypropylmethylcellulose, sodium carboxymethylcellulose, pectin, etc. In no way at all, however, are these polymers suitable for producing rapid-release forms where a drug of low solubility is to be quickly dissolved and provided to the entire surface area of the stomach and small intestine for absorption.

EP 0211268 describes minoxidil salts with polymeric polyanions that exhibit delayed release and are used for dermal application. Minoxidil is a drug which comprises four groups capable of salt formation, and the corresponding polymeric salts were less soluble than the hydrochloride. As a result of the numerous groups capable of salt formation, the dissociation of the salt is greatly reduced, and the solubility is not improved by comparison with the hydrochloride. Oral applications are not described.

U.S. Pat. No. 4,997,643 describes a biocompatible, film-forming delivery system for topical application that comprises a polymeric salt with a carboxyl-carrying component. The drug used is, again, minoxidil, which has the special characteristics identified above. Oral applications are not described.

U.S. Pat. No. 4,248,855 claims liquid preparations which comprise salts of basic drugs and water-insoluble polymers, and which possess a slow-release effect. Through the use of water-insoluble polymers, the preparations do not exhibit rapid release and do not exhibit high solubility over a wide pH range.

From U.S. Pat. No. 5,736,127 it is known that salts can be formed from basic drugs and polymers with carboxyl-amidine-carboxyl triads. On account of the high molecular weights, the polymers are gel-forming, and so the release of the active ingredients is delayed. Suitability for rapid-release tablets is absent.

U.S. Pat. No. 4,205,060 describes microcapsules with delayed release which comprise, in the core, a salt of a basic drug with a carboxyl-containing polymer, surrounded by a water-insoluble polymer. The carboxyl-containing polymer reduces the release of the soluble drugs used.

Salts of ranitidine with polycarboxylic acids are described in EP 0721785. The polycarboxylic acids bind the ranitidine and are said to reduce its bitterness. However, low molecular weight salts of ranitidine are highly soluble, and so the polycarboxylic acids merely restrict the mobility and diffusion of the ranitidine, causing it to reach the bitter receptors less rapidly.

WO 2009/074609 discloses salts of active ingredients with polymeric counterions, it being possible for the polymers to have both anionic and cationic character. Anionic polymers preferably carry carboxyl groups or sulfonate groups.

U.S. Pat. No. 5,652,330 describes polycondensates with citric acid that either represent polycondensates of the citric acid with itself, or in which alcohol components are incorporated by condensation, in a deficit amount, with a molar ratio of 100:1 to 2.5:1. The polycondensates described therein are used in detergents, especially for preventing deposits.

WO 2007/125028 describes water-soluble, hyperbranched polyesters for solubilizing hydrophobic active ingredients in aqueous medium. The hyperbranched polyesters described therein comprise units different from citric acid, and do not exhibit preferred solubilization of basic active ingredients.

DE 2633418 describes polyesters which contain sulfonate groups and which, based on the total fraction of carboxylic acid monomers, may comprise up to 40 mol % of citric acid, and describes their use in hair treatment compositions.

### SUMMARY

In one embodiment of the invention, provided is a branched polyester obtained by polycondensation of citric acid with at least one polyalcohol having at least two hydroxyl groups, wherein the molar ratio of citric acid to polyalcohol is 2.4:1 to 1:3. In certain embodiments, the molar ratio of citric acid to polyalcohol is 2.4:1 to 1:2.4. In further embodiments, the molar ratio of citric acid to polyalcohol is 2:1 to 1:2.

In other embodiments, provided is a branched polyester obtained by polycondensation of citric acid and at least one other polycarboxylic acid with at least one polyalcohol having at least two hydroxyl groups. In a further embodiment, molar fraction of the other polycarboxylic acid components is smaller than the molar fraction of citric acid.

In some embodiments, the citric acid or citric acid and other polycarboxylic acid are polycondensed with a mixture of two or more polyalcohols, each polyalcohol having at least two hydroxyl groups.

In certain embodiments, the polyalcohols are reaction products of compounds having at least two hydroxyl groups and ethylene oxide or propylene oxide, or with mixtures of ethylene oxide and propylene oxide, or mixtures of such reaction products. In one embodiment, the polyalcohols are selected from the group consisting of glycerol, diglycerol, triglycerol, trimethylolethane, trimethylolpropane, di(trimethylolpropane), 1,2,4-butanetriol, 1,2,6-hexanetriol, pentaerythritol, the reaction products thereof with ethylene oxide or propylene oxide or with mixtures of ethylene oxide and propylene oxide, and combinations thereof. In another embodiment, the polyalcohols are polyethylene glycols having molecular weights of 150 to 1500 g/mol.

In a certain embodiment, the polyester has a molecular weight Mn of 500 to 5,000 g/mol, preferably 1,000 to 5,000 g/mol. In other embodiments, the polyester has a molecular weight Mw of 1,500 to 50,000 g/mol, preferably 2,000 to 30,000 g/mol.

In yet another embodiment, the polyester has an acid number of 60 to 600 mg KOH/g polymer, preferably 80 to 500 mg KOH/g polymer.

Also provided is a process for preparing a polyester comprising polycondensation of citric acid with at least one polyalcohol having at least two hydroxyl groups, wherein the molar ratio of citric acid to polyalcohol is 2.4:1 to 1:3. In one embodiment, the molar ratio of citric acid to polyalcohol is 2.4:1 to 1:2.4. In a further embodiment, the molar ratio of citric acid to polyalcohol is 2:1 to 1:2.

In one embodiment, the polycondensation takes place in the presence of a catalyst. In further embodiments, the polycondensation takes place in the presence of a catalyst selected from the group consisting of acidic inorganic, organometallic or organic catalysts, or mixtures thereof.

Also provided is a method of improving the solubility for substances of low solubility in water comprising using a branched polyester according to claim 1 as a solubility improver for substances of low solubility in water. In one embodiment, the substances of low solubility in water carry basic functional groups. In another embodiment, the solubility improvement is accomplished by the formation, between substance of low solubility and polyester, of a salt or a salt-like structure.

In one embodiment, the substances of low solubility in water are bioactive substances or effect substances. In a further embodiment, the bioactive substances are active pharmaceutical, cosmetic, agrochemical or dietetic ingredients or nutritional supplements. In another embodiment, the method of improving solubility is for producing presentation forms.

Another embodiment of the invention provides process for preparing a polymeris salt of a basic active ingredient comprising preparing a mixture of active ingredient and branched polyesters, the branched polyesters being obtained by polycondensation of citric acid with at least one polyalcohol having at least two hydroxyl groups, the molar ratio of citric acid to polyalcohol being 2.4:1 to 1:3; and heating the mixture above the glass transition temperature of the polymer, or heating the mixture above the melting point of the polymer, or preparing the mixture in the form of a solution and then freeing the solution from the solvent. In another embodiment, the polycondensation is performed with citric acid and another polycarboxylic acid.

### DETAILED DESCRIPTION

Embodiments of the present invention relate to branched polyesters comprising citric acid as a synthesis component, to processes for preparing such polyesters, and to their use for solubilizing basic active pharmaceutical ingredients of low solubility.

According to one or more embodiments, provided are polymers for improving the solubility in aqueous media of active ingredients of low solubility. In one or more embodiments, provided are solubilizers for basic active ingredients capable of salt formation, and for corresponding active-ingredient salts, which, following processing to oral dosage forms, allow higher solubility of the active ingredient and more rapid release by comparison with the conesponding hydrochloride salt. In one or more embodiments, provided are salts which permit effective tabletability of the active ingredient.

According to one or more embodiments, provided are suitable polymers for the formation of polymeric active-ingredient salts.

In one or more embodiments, provided are branched polyesters, by means of a technically simple and inexpensive process, as a polymer component for polymeric active-ingredient salts, which possess a high number of acid functions and are made up of monomers of low toxicity and good biodegradability.

The branched polyesters are obtained by polycondensation of citric acid with at least one polyalcohol and, if desired, further polycarboxylic acid components, a polyalcohol being understood to be a molecule having at least two hydroxyl groups, and the molar ratio of citric acid to polyalcohol being 2.4:1 to 1:3.

The molar ratio of citric acid to polyalcohol is preferably 2.4:1 to 1:2.4, more preferably 2:1 to 1:2.

In accordance with certain embodiments of the invention, such branched polyesters are suitable for the solubilization of active ingredients that are of low solubility in water, through formation of polymeric active-ingredient salts.

Of preferred suitability are highly branched polyesters, and in a special case hyperbranched polyesters as well. Highly branched polyesters for the purposes of this invention are non-crosslinked polyesters having hydroxyl and carboxyl groups, which are both structurally and molecularly non-uniform. Non-crosslinked in the context of this specification means that there is a degree of crosslinking of less than 15% by weight, preferably of less than 10% by weight, determined via the insoluble fraction of the polymer.

Highly branched polyesters may on the one hand have a structure originating from a central molecule, in the same way as for dendrimers, but with a non-uniform chain length of the branches. On the other hand, they may also have a linear construction, with functional side groups, or else may have linear and branched moieties, as a combination of the two extremes. With regard to the definition of dendrimers and highly branched polymers see also P. J. Flory, J. Am. Chem. Soc. 1952, 74, 2718 and H. Frey et al., Chemistry—A European Journal, 2000, 6, No. 14, 2499.

“Hyperbranched” means, in connection with the present invention, that the degree of branching (DB) of the polymer is 10% to 99.9%, preferably 20% to 99%, more preferably 20% to 95%. This degree of branching DB is defined as DB (%)=(T+Z)/(T+Z+L)×100, where
T is the average number of terminally attached monomer units;
Z is the average number of branch-forming monomer units; and
L is the average number of linearly attached monomer units.

“Dendrimeric” means, in connection with the present invention, that the degree of branching is 99.9%-100%. With regard to the definition of the degree of branching see H. Frey et al., Acta Polym. 1997, 48, 30-35.

Citric acid in accordance with the invention means citric acid anhydrate, citric anhydride, the hydrates of citric acid, such as citric acid monohydrate, for example, and alkali metal, alkaline earth metal or ammonium salts of citric acid. In accordance with the invention it is also possible to use isocitric acid instead of citric acid.

The citric acid or aforementioned derivatives thereof may also be used in a mixture with the mono-, di- or tri-(C1-C4)alkyl esters of citric acid, such as the methyl or ethyl esters, for example.

Suitable polyalcohols in accordance with the certain embodiments of the invention are alcohols having at least two hydroxyl groups and up to six hydroxyl groups. Preferred suitability is possessed by diols or triols or by mixtures of different diols and/or triols. Suitable polyalcohols are, for example, polyetherols. The polyetherols may be obtained by reaction with ethylene oxide, propylene oxide and/or butylene oxide. Especially suitable are polyetherols based on ethylene oxide and/or propylene oxide. Mixtures of such polyetherols can also be used.

Examples of suitable diols include ethylene glycol, propane-1,2-diol, propane-1,3-diol, butane-1,2-diol, butane-1,3-diol, butane-1,4-diol, butane-2,3 -diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1, 5-diol, hexane- 1,6-diol, hexane-2,5 diol, heptane-1,2-diol 1,7-heptanediol, 1,8-octanediol, 1,2-octanediol, 1,9-nonanediol, 1,2decanediol, 1,10-decanediol, 1,2-dodecanediol, 1,12-dodecanediol, 1,5-hexadiene-3 ,4-diol, 1,2- and 1,3-cyclopentanediols, 1,2-, 1,3- and 1,4-cyclohexanediols, 1,1-, 1,2-, 1,3-, and 1,4-bis(hydroxymethyl)cyclohexanes, 1,1-, 1,2-, 1,3-, and 1,4-bis(hydroxyethyl)cyclohexanes, neopentylglycol, (2)-methyl-2,4-pentanediol, 2,4-dimethyl-2,4-pentanediol, 2-ethyl-1,3-hexanediol, 2, 5-dimethyl-2, 5-hexanediol, 2,2,4-trimethyl- 1, 3-pentanediol, pinacol, diethylene glycol, triethylene glycol, dipropylene glycol, tripropylene glycol, polyethylene glycols HO(CH₂CH₂O)ₙ—H or polypropylene glycols HO(CH[CH₃]CH₂O)ₙ—H, where n is an integer and n≧4, polyethylene-polypropylene glycols, it being possible for the sequence of the ethylene, oxide units and of the propylene oxide units to be blockwise or random, polytetra-methylene glycols, preferably up to a molar weight of up to 5000 g/mol, poly-1,3-propanediols, preferably with a molar weight of up to 5000 g/mol, polycaprolactones or mixtures of two or more representatives of the above compounds. For example, one to six, preferably one to four, more preferably one to three, very preferably one to two, and more particularly one diol may be used. One or even both hydroxyl groups in the aforementioned diols may be substituted by SH groups. Diols used with preference are ethylene glycol, 1,2-propanediol, 1,3-propanediol, 1,4-butanediol, 1,5-pentanediol, 1,6-hexanediol, 1,8-octanediol, 1,2-, 1,3-, and 1,4-cyclohexanediol, 1,3- and 1,4-bis(hydroxymethyl)cyclohexane, and also diethylene glycol, triethylene glycol, dipropylene glycol, tripropylene glycol, and polyethylene glycols having an average molecular weight of between 200 and 1000 g/mol.

The dihydric polyalcohols may optionally also comprise further functionalities such as, for example, carbonyl, carboxyl, alkoxycarbonyl or sulfonyl, such as, for example, dimethylolpropionic acid or dimethylolbutyric acid, and also their C₁-C₄-alkyl esters, but preferably the alcohols have no further functionalities.

Examples of suitable triols or polyalcohols with higher functionality include glycerol, trimethylolmethane, trimethylolethane, trimethylolpropane, bis(trimethylolpropane), trimethylolbutane, trimethylolpentane, 1,2,4-butanetriol, 1,2,6-hexanetriol, tris(hydroxymethyl)amine, tris(hydroxyethyl)amine, tris(hydroxypropyl)amine, pentaerythritol, diglycerol, triglycerol or higher condensation products of glycerol, di(trimethylolpropane), di(pentaerythritol), tris(hydroxymethyl)isocyanurate, tris(hydroxyethyl)isocyanurate (THEIC), tris(hydroxypropyl)isocyanurate, and N-[1,3-bis(hydroxymethyl)-2,5-dioxo-4-imidazolidinyl]-N,N′-bis(hydroxymethyl)urea.

Also suitable, furthermore, are sugars or sugar alcohols such as, for example, glucose, fructose or sucrose, sugar alcohols such as, for example, sorbitol, mannitol, threitol, erythritol, adonitol (ribitol), arabitol (lyxitol), xylitol, dulcitol (galactitol), maltitol, isomalt, or inositol.

Suitability is further possessed by polyetherols with a functionality of three or more which are based on alcohols with a functionality of three or more and are obtained by reaction with ethylene oxide, propylene oxide and/or butylene oxide, or mixtures of such reaction products.

Particularly preferred in this context are glycerol, diglycerol, triglycerol, trime-thylolethane, trimethylolpropane, di(trimethylolpropane), 1,2,4-butanetriol, 1,2,6-hexanetriol, pentaerythritol, sucrose or sorbitol, and also their polyetherols based on ethylene oxide and/or propylene oxide.

It is also possible to use mixtures of polyalcohols having a functionality of at least three. For example, one to six, preferably one to four, more preferably one to three, very preferably one to two, and more particularly one at least trifunctional alcohol can be used.

In one embodiment of the invention, in addition to the citric acid, it is possible to incorporate, by condensation, further carboxylic acid components, more particularly dicarboxylic acids or hydroxycarboxylic acids, and in this case the molar fraction of such further carboxylic acid components is lower than the fraction of citric acid, and is preferably not to be more than 30 mol %, based on the amount of citric acid used. Examples of suitable dicarboxylic acids include aliphatic dicarboxylic acids, such as oxalic acid, malonic acid, succinic acid, glutaric acid, adipic acid, pimelic acid, suberic acid, azelaic acid, sebacic acid, undecane-α,ω-dicarboxylic acid, dodecane-α,ω-dicarboxylic acid, cis- and trans-cyclohexane-1,2-dicarboxylic acid, cis- and trans-cyclohexane-1,3-dicarboxylic acid, cis- and trans-cyclohexane-1,4-dicarboxylic acid, cis- and trans-cyclopentane-1,2-dicarboxylic acid, cis- and trans-cyclopentane-1,3-dicarboxylic acid. It is also possible, moreover, to use aromatic dicarboxylic acids, such as phthalic acid, isophthalic acid or terephthalic acid, for example. Unsaturated dicarboxylic acids as well, such as maleic acid, fumaric acid, itaconic acid, mesaconic acid, glutaconic acid or citraconic acid, can be used.

Examples of suitable hydroxycarboxylic acids include aliphatic hydroxycarboxylic acids such as hydroxyacetic acid (glycolic acid), hydroxypropionic acid (lactic acid), hydroxyvaleric acid, hydroxysuccinic acid (malic acid), China acid (2,3,4,5-tetrahydroxycyclo-hexanecarboxylic acid), dimethylolpropionic acid or dimethylolbutyric acid, or lactones, such as butyrolactone, valerolactone or caprolactone.

The stated dicarboxylic acids or hydroxycarboxylic acids may also be substituted by one or more radicals selected from:
C₁-C₂₀-alkyl groups, examples being methyl, ethyl, n-propyl, isopropyl, n-butyl, isobutyl, secbutyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, trimethylpentyl, n-nonyl, n-decyl, n-dodecyl, n-tetradecyl, n-hexadecyl, n-octadecyl, or n-eicosyl,
C₂-C₂₀-alkenyl groups, examples being butenyl, hexenyl, octenyl, decenyl, dodecenyl, tetradecenyl, hexadecenyl, octadecenyl or eicosenyl,
C₃-C₁₂-cycloalkyl groups, examples being cyclopropyl, cyclobutyl, cyclopentyl, cyclohexyl, cycloheptyl, cyclooctyl, cyclononyl, cyclodecyl, cycloundecyl, and cyclododecyl; cyclopentyl, cyclohexyl, and cycloheptyl are preferred;
alkylene groups such as methylene or ethylidene, or
C₆-C₁₄-aryl groups such as, for example, phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, more preferably phenyl.

Exemplary representatives that may be given of substituted dicarboxylic acids or their derivatives are as follows: 2-methylmalonic acid, 2-ethylmalonic acid, 2-phenylmalonic acid, 2-methylsuccinic acid, 2-ethylsuccinic acid, 2-phenylsuccinic acid, 3,3-dimethylglutaric acid, dodecenylsuccinic acid, hexadecenylsuccinic acid, octadecenylsuccinic acid, and reaction products of polyisobutylenes with an enophile selected from the group consisting of fumaryl dichloride, fumaric acid, maleyl dichloride, maleic anhydride and/or maleic acid, preferably with maleic anhydride or maleyl dichloride, more preferably with maleic anhydride, to give polyisobutylene-substituted succinic acid derivatives in which the polyisobutylene group can have a number-average molecular weight Mₙ of 100 to 100 000 daltons. This reaction takes place in accordance with the methods known to the skilled worker, and preferably as described in German laid-open specifications DE-A 195 19 042, preferably from page 2 line 39 to page 4 line 2 and more preferably from page 3 lines 35-58 therein, and DE-A 43 19 671, preferably from page 2 line 30 to line 68 therein, and DE-A 43 19 672, preferably from page 2 line 44 to page 3 line 19 therein, describing methods for the reaction of polyisobutylenes with enophiles.

The dicarboxylic acids and other, further carboxylic acid components can be used either as they are or in the form of derivatives.

Derivatives preferably mean the following:

The corresponding anhydrides in monomeric or else polymeric form, monoalkyl or dialkyl esters, preferably mono- or di-C1-C4 alkyl esters, more preferably monomethyl or dimethyl esters or the corresponding monoethyl or diethyl esters, and also monovinyl and divinyl esters, and also mixed esters, preferably mixed esters with different C1 -C4 alkyl components, more preferably mixed methyl ethyl esters.

Among these, the anhydrides and the monoalkyl or dialkyl esters are preferred; particular preference is given to the anhydrides and the mono- or di-C1-C4 alkyl esters, and especial preference to the anhydrides. C1-C4-Alkyl for the purposes of this specification denotes methyl, ethyl, isopropyl, n propyl, n-butyl, isobutyl, sec-butyl, and tert-butyl, preferably methyl, ethyl, and n butyl, more preferably methyl and ethyl, and very preferably methyl.

As further carboxylic acid components it is particularly preferred to use malonic acid, succinic acid, hydroxysuccinic acid, glutaric acid, adipic acid, sebacic acid, octadecenylsuccinic anhydride, 1,2-, 1,3- or 1,4-cyclohexanedicarboxylic acids (hexahydrophthalic acids as cis or trans compounds, or mixtures thereof), China acid, phthalic acid, isophthalic acid, terephthalic acid or their anhydrides or monoalkyl or dialkyl esters.

In accordance with this embodiment of the invention the amount of dicarboxylic acid or other, further carboxylic acid components is preferably not more than 30 mol % relative to the amount of citric acid used, more preferably not more than 20 mol %, very preferably not more than 15 mol %.

In accordance with another preferred embodiment of the invention the only carboxylic acid component used is citric acid.

The process of certain embodiments of the invention for preparing the branched polyesters based on citric acid may be carried out in bulk or in the presence of an organic solvent. Examples of suitable solvents include hydrocarbons such as paraffins or aromatics. Particularly suitable paraffins are n-heptane and cyclohexane. Particularly suitable aromatics are toluene, ortho-xylene, meta-xylene, para-xylene, xylene in the form of an isomer mixture, ethylbenzene, chlorobenzene, and ortho- and meta-dichlorobenzene. Additionally suitable as solvents in the absence of acidicatalysts are, very particularly, ethers, such as dioxane or tetrahydrofuran, and ketones, such as methyl ethyl ketone and methyl isobutyl ketone, for example.

The amount of added solvent in accordance with the invention is at least 0.1% by weight, based on the mass of the starting materials that are used and are to be reacted, preferably at least 1% by weight, and more preferably at least 10% by weight. It is also possible to employ excesses of solvent, based on the mass of starting materials used and to be reacted, such as, for example, from 1.01 to 10-fold.

In one preferred embodiment the reaction is carried out without addition of solvent.

For carrying out the process, it is possible to operate in the presence of a water-remover additive, which is added at the beginning of the reaction. Suitable examples include molecular sieves, especially molecular sieve 4 Å, MgSO₄ and Na₂SO₄. It is also possible to add further water remover during the reaction, or to replace water remover by fresh water remover. It is also possible to remove alcohol and/or water formed during the reaction, by distillation, and to use, for example, a water separator, in which the water is removed with the aid of an azeotrope former.

The process can be carried out in the absence of catalysts. It is preferred, however, to operate in the presence of at least one catalyst. These are preferably acidic inorganic, organometallic or organic catalysts, or mixtures of two or more acidic inorganic, organometallic or organic catalysts.

Acidic catalysts are also taken for the purposes of this specification to include Lewis acids, in other words those compounds, according to Rompps Chemie-Lexikon, entry heading “Acid-base concept”, which are able to accept an electron pair into the valence shell of one of their atoms.

Acidic inorganic catalysts in the sense of the present invention include, for example, sulfuric acid, sulfates, and hydrogen sulfates, such as sodium hydrogen sulfate, phosphoric acid, phosphonic acid, hypophosphorous acid, aluminum sulfate hydrate, alum, acidic silica gel (pH≦6, especially≦5), and acidic aluminum oxide. It is additionally possible to use, for example, aluminum compounds of the general formula Al(OR¹)₃, and titanates of the general formula Ti(OR¹)₄, as acidic inorganic catalysts, in which case the radicals R¹ may in each case be identical or different and are selected independently of one another from:
C₁-C₂₀-Alkyl radicals, examples being methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, isoheptyl, n-octyl, 2-ethylhexyl, n-nonyl, n-decyl, n-dodecyl, n-hexadecyl or n-octadecyl;
C₃-C₁₂-Cycloalkyl radicals, examples being cyclopropyl, cyclobutyl, cyclopentyl, cyclohexyl, cycloheptyl, cyclooctyl, cyclononyl, cyclodecyl, cycloundecyl, and cyclododecyl; preferably cyclopentyl, cyclohexyl, and cycloheptyl.

The radicals R¹ in Al(OR¹)₃ and Ti(OR¹)₄ are preferably in each case identical and selected from n-butyl, isopropyl, 2-ethylhexyl, n-octyl, decyl or dodecyl.

Preferred acidic organometallic catalysts are selected, for example, from dialkyltin oxides R¹₂SnO or dialkyltin diesters R¹₂Sn(OR²)₂, where R¹ is as defined above and may be identical or different.

R² may have the same definitions as R¹ and may additionally be C₆-C₁₂-aryl, examples being phenyl, o-, m- or p-tolyl, xylyl or naphthyl. R² may in each case be identical or different.

Examples of organotin catalysts are tin(II) n-octanoate, tin(II) 2-ethylhexanoate, tin(II) laurate, dibutyltin oxide, diphenyltin oxide, dibutyltin dichloride, dibutyltin diacetate, dibutyltin dilaurate, dibutyltin dimaleate or dioctyltin diacetate. Also conceivable are organo-antimony, organobismuth or organoaluminum catalysts.

Particularly preferred representatives of acidic organometallic catalysts are dibutyltin oxide, diphenyltin oxide, and dibutyltin dilaurate.

Preferred acidic organic catalysts are acidic organic compounds having, for example, phosphate groups, sulfonic acid groups, sulfate groups or phosphonic acid groups. Particularly preferred are sulfonic acids such as para-toluenesulfonic acid, for example. It is also possible to use acidic ion exchangers as acidic organic catalysts, examples being polystyrene resins which contain sulfonic acid groups and are crosslinked with about 2 mol % of divinylbenzene.

Use may also be made of combinations of two or more of the aforementioned catalysts. It is possible, as well, to use those organic or organometallic or else inorganic catalysts which are present in the form of discrete molecules, in immobilized form, for example, on silica gel or on zeolites.

If it is desired to use acidic inorganic, organometallic or organic catalysts, then the amount used is preferably 1 to 10 000 ppm of catalyst, more preferably 2 to 5000 ppm, based on the total mass of the hydroxyl- and of the carboxyl-containing compounds.

If it is desired to use acidic inorganic, organometallic or organic catalysts, then the process in accordance with the invention is carried out at temperatures of 60 to 140° C. It is preferred to operate at temperatures from 80 to 140° C., more preferably at 100 to 130° C.

It is also possible in accordance with the invention to use enzymes as catalysts, although their use is less preferred.

Enzymes which can be used for this purpose are selected, for example, from hydrolases (E.C. 3.-.-.-), and among these particularly from the esterases (E.C. 3.1.-.-), lipases (E.C. 3.1.1.3), glycosylases (E.C. 3.2.-.-), and proteases (E.C. 3.4.-.-), in free form or in a form immobilized physically or chemically on a support, preferably lipases, esterases or proteases, and more preferably esterases (E.C. 3.1.-.-). Especially preferred are Novozyme® 435 (lipase from Candida antarctica B) or lipase from Alcaligenes sp., Aspergillus sp., Mucor sp., Penicillum sp., Geotricum sp., Rhizopus sp., Burkholderia sp., Candida sp., Pseudomonas sp., Thermomyces sp. or porcine pancreas, particular preference being given to lipase from Candida antarctica B or from Burkholderia sp. The enzymes listed are available commercially, as for example from Novozymes Biotech Inc., Denmark.

The enzyme content of the reaction medium is generally in the range from about 0.1% to 10% by weight, based on the sum of the components used.

If it is desired to use enzymes as catalysts, then the process is carried out in accordance with the invention at temperatures of 20 and up to 120° C., preferably 20 to 100° C., and more preferably 20 to 80° C.

In one embodiment, the process is carried out preferably under inert gas atmosphere, i.e., under a gas which is inert under the reaction conditions, as for example under carbon dioxide, combustion gases, nitrogen or noble gases, particulalrly argon.

The pressure conditions of the process are generally not critical. It is possible to operate at slightly reduced pressure, as for example at 0.001 to 0.05 MPa. The process can also be carried out at pressures above 0.05 MPa. For reasons of simplicity it is preferred to carry out reaction at atmospheric pressure; also possible, however, is a slightly elevated pressure, of up to 0.12 MPa, for example. Another option is to operate under significantly increased pressure, as for example at pressures of up to 1 MPa. Preference is given to reaction at reduced or atmospheric pressure, more preferably at atmospheric pressure.

The reaction time in the process is typically 10 minutes to 5 days, preferably 30 minutes to 48 hours, more preferably 1 to 24 hours, and very preferably 1 to 12 hours.

After the end of the reaction it is easy to isolate the high-functionality branched polyesters, by means, for example, of filtration to remove the catalyst and, if desired, stripping to remove the solvent, the stripping of the solvent typically being conducted under reduced pressure. Other highly suitable methods for workup are precipitation of the polymer following addition of water, and subsequent washing and drying.

If necessary, the reaction mixture can be subjected to a decoloring operation, by means, for example, of treatment with activated carbon or metal oxides, such as aluminum oxide, silicon oxide, magnesium oxide, zirconium oxide, boron oxide or mixtures thereof, for example, in amounts, for example, of 0.1% to 50% by weight, preferably 0.5% to 25% by weight, more preferably 1% to 10% by weight, and at temperatures, for example, of 10 to 140° C., preferably 20 to 130° C., and more preferably 30 to 120° C.

This can be done by adding the decolorizing agent in powder or granule form to the reaction mixture, followed by filtration or by passage of the reaction mixture over a bed of the decolorizing agent in the form of any desired, suitable shaped bodies.

The decolorizing of the reaction mixture can take place at any desired point in the workup procedure—for example, at the stage of the crude reaction mixture or after any preliminary washing, neutralizing, washing or solvent removal.

The reaction mixture may also be subjected to a preliminary wash and/or to neutralization and/or to a subsequent wash, but preferably only to neutralization. If desired, neutralization and preliminary wash may also be switched in their order.

From the aqueous phase from washing and/or neutralization it is possible to recover products of value by acidification and extraction with a solvent, at least in part, and to use them anew.

In terms of process engineering, the techniques and apparatus that can be used for washing or neutralization in the process include all conventional extraction and washing techniques and apparatus, examples being those described in Ullmann's Encyclopedia of Industrial Chemistry, 6th ed., 1999 Electronic Release, Chapter: liquid-liquid extraction apparatus.

These extractions, for example, may be single-stage or multistage, preferably single-stage, extractions, and may take place in cocurrent or countercurrent mode, preferably countercurrent mode.

In one preferred embodiment, however, it is possible to omit washing, neutralization, and decolorizing.

In certain embodiments, the branched polyesters have molecular weights Mₙ of 500 to 5000 g/mol, preferably 1000 to 5000 g/mol. In further embodiments, the molecular weights M_{w} of the polyesters may be from 1500 to 50 000 g/mol, preferably 2000 to 30 000 g/mol.

In certain embodiments, the branched polyesters have acid numbers of 60 to 600 mg KOH/g polymer, preferably 80 to 500 mg KOH/g polymer, and very preferably 100 to 400 mg KOH/g polymer.

In another emodment, the branched polyesters have glass transition temperatures in the range from −50 to +50° C., preferably −40 to +40° C., and very preferably −30 to +40° C. The glass transition temperature is determined by means of DSC (differential scanning calorimetry) with a heating rate of 10 K/min

The branched polyesters based on citric acid are suitable as solubilizers for improving the solubility of substances of low solubility in water. They are especially suitable for preparing polymeric active-ingredient salts for solubility improvement for all substances which are insoluble, of low solubility or of poor solubility in water and which are capable of forming salts with the acidic groups of the polymer component.

Substances of low solubility in water that are contemplated in accordance with the invention include bioactive substances or effect substances such as pigments.

Examples of suitable bioactive substances include active pharmaceutical, cosmetic, agrochemical or dietetic ingredients or nutritional supplements.

According to DAB 9 (German Pharmocopeia), the solubility of active pharmaceutical ingredients is classified as follows: of poor solubility (soluble in 30 to 100 parts of solvent); of low solubility (soluble in 100 to 1000 parts of solvent); virtually insoluble (soluble in more then 10 000 parts of solvent). In accordance with the invention, the active ingredients of poor solubility, low solubility or virtual insolubility are referred to collectively as “of low solubility”. These active ingredients may come from any area of indication.

Examples that may be given here are antihypertensives, vitamins, cytostatics—especially taxol, anesthetics, neuroleptics, antidepressants, antibiotics, antimycotics, fungicides, chemotherapeutics, urologicals, platelet aggregation inhibitors, sulfonamides, spasmolytics, hormones, immunoglobulins, sera, thyroid therapeutics, psychoactive drugs, antiparkinson agents and other antihyperkinetics, ophthalmologicals, neuropathy products, calcium metabolism regulators, muscle relaxants, narcotics, lipid-lowering agents, hepatotherapeutics, coronary agents, cardiac agents, immunotherapeutics, regulatory peptides and their inhibitors, hypnotics, sedatives, gynecologicals, gout remedies, fibrinolytics, enzyme products and tranport proteins, enzyme inhibitors, emetics, slimming agents, bloodflow stimulators, diuretics, diagnostic agents, corticoids, cholinergics, biliary therapeutics, antiasthmatics, broncholytic agents, beta-receptor blockers, calcium antagonists, ACE inhibitors, arteriosclerosis remedies, antiphlogistics, anticoagulants, antihypotensives, antihypoglycemics, antihypertensives, anti-fibrinolytics, antiepileptics, antiemetics, antidotes, antidiabetics, antiarrhythmics, antianemics, antiallergics, anthelmintics, analgesics, analeptics, aldosterone antagonists or active antiviral ingredients, or active ingredients for the treatment of HIV infections and of AIDS.

In the preparation of the polymers, it should preferably be ensured that they do not have any low molecular weight anions such as, for example, chloride, sulfate, etc., which can lead to salts of low solubility with active ingredients.

From case to case, however, it may be advisable to use the polymeric salts of the invention in a mixture with low molecular weight salts, of relatively low solubility, of the active ingredients, or else in a mixture with the corresponding partially neutralized polymeric salts.

Salt formation between polymer and active ingredient may be stoichiometric, based on the number of acid groups in the polymer. It is, however, also possible to carry out the reaction to form the salt in a nonstoichiometric way. The salts of the invention may be prepared in principle by drying, melting or precipitation processes.

Drying of an aqueous or organic solution

In one embodiment, the active ingredient and the polymer are dissolved in water or organic solvents and the solution is then dried. Dissolution may also take place at elevated temperatures (30-200° C.) and under pressure.

In principle, all modes of drying are possible, such as, for example, spray drying, fluidized-bed drying, paddle drying, freeze drying, vacuum drying, belt drying, roller drying, carrier-gas drying, evaporation, etc.

### Melting Processes

In another embodiment, the active ingredient is mixed with the polymer. By heating to temperatures of 50 to 200° C., preferably 50 to 140° C., and especially 50 to 130° C., the polymeric salt is prepared. In this case, temperatures above the glass transition temperature of the polymer or the melting point of the active ingredient are advantageous. By addition of a plasticizing auxiliary such as water, organic solvent or typical organic plasticizers, for example, it is possible to lower the processing temperature accordingly. Particularly advantageous in this respect are auxiliaries which are very easy to remove again by evaporation afterward, i.e., which have a boiling point of below 180° C., preferably below 150° C. This type of preparation may be performed, preferably, in an extruder.

The extruder is preferably a co-rotating twin-screw extruder. The screw configuration may be shearing to different degrees according to product. It is advisable to use kneading elements, particularly in the melting zone. It is also possible here to use reverse kneading elements. Downstream of the melting zone there may be a degassing zone, which is advantageously operated at atmospheric pressure, but if desired may also be operated under reduced pressure.

Discharge of the product can take place via circular dies having diameters of 1 to 5 mm, preferably 2 to 3 mm The extruders may also be equipped with die plates. Other forms of die, such as slot dies, may likewise be used, especially if a relatively large material throughput is intended.

The extruders are typically equipped with heatable barrels. The resulting product temperature, however, is dependent on the degree of shearing of the screw element used, and may sometimes be 20-30° C. higher than the setpoint barrel temperature.

Normally, extruders with a length of 10D to 40D are suitable.

In principle, two or more active-ingredient bases may be reacted with the polymer in the extruder to form the salt.

The extrudate strands emerging from the extruder can be comminuted in a conventional way, as for example by chopping techniques.

The resulting strands can be processed with a granulator to give granules, which in turn may be comminuted further (ground) into a powder. The granules or powder can be poured into capsules or can be pressed into tablets using customary tableting auxiliaries.

In one particular version of extrusion, the polymer may first be fed to the extruder and melted. The active-ingredient base is then added via a second entry point. Additional active-ingredient bases can be metered in via further intake points.

A further possibility is to use water, organic solvents, buffer substances or plasticizers during the extrusion in order to accelerate the reaction of the active-ingredient base with the acidic polymer. Water or volatile alcohols in particular are appropriate for this purpose. This process allows reaction to take place at a relatively low temperature. The quantities of solvent and/or plasticizer are typically between 0% and 30% of the extrudable mass. The water or solvent can be removed simply through a degassing point in the extruder, under atmospheric pressure, or by application of reduced pressure. Alternatively, these components evaporate when the extrudate leaves the extruder and the pressure drops to atmospheric pressure. In the case of less volatile components, the extrudate may be subjected, correspondingly, to subsequent drying.

Two further embodiments involve either dissolving the active ingredient in a solvent and feeding it to the polymer in the extruder, or dissolving the polymer in a solvent and feeding it to the active ingredient.

In accordance with one embodiment of the preparation process, directly following the extrusion, the thermoplastic mass is calendered to give a tablet-like compact, which constitutes the final presentation form. In this variant it may be useful to add further constituents such as, for example, polymers for adjusting the glass transition temperature and the melt viscosity, disintegrants, solubilizers, plasticizers, release modifier auxiliaries, retardants, polymers resistant to gastric juice, colorants, flavorings, sweeteners, and further additives, even before or during the extrusion. In principle these substances may also be used when the extrudate is first comminuted and then pressed to form tablets.

The water content of the extruded products is generally below 5% by weight.

In the preparation of solid dosage forms of the polymeric active-ingredient salts, customary pharmaceutical excipients may be included, if desired, in the processing operations. These excipients are substances from the classes of the fillers, plasticizers, solubilizers, binders, silicates, disintegrants, adsorbents, lubricants, flow agents, colorants, stabilizers such as antioxidants, wetting agents, preservatives, mold release agents, flavors or sweeteners, preferably fillers, plasticizers, and solubilizers.

Fillers which can be added include, for example, inorganic fillers such as oxides of magnesium, aluminum, silicon, titanium carbonate or calcium carbonate, calcium phosphates or magnesium phosphates, or organic fillers such as lactose, sucrose, sorbitol or mannitol.

Examples of suitable plasticizers include triacetin, triethyl citrate, glyceryl monostearate, low molecular weight polyethylene glycols or poloxamers.

Suitable solubilizers are interface-active substances having an HLB (hydro-philic-lipophilic balance) of more than 11, examples being hydrogenated castor oil ethoxylated with 40 ethylene oxide units (Cremophor® RH 40), castor oil ethoxylated with 35 ethylene oxide units (Cremophor® EL), Polysorbate 80, poloxamers or sodium lauryl sulfate.

Lubricants which can be used include stearates of aluminum, calcium, magnesium, and tin, and also magnesium silicate, silicones, and the like.

Flow agents which can be used include, for example, talc or colloidal silicon dioxide.

An example of a suitable binder is microcrystalline cellulose.

Disintegrants may be crosslinked polyvinylpyrrolidone or crosslinked sodium carboxymethylstarch. Stabilizers may be ascorbic acid or tocopherol.

Colorants are, for example, iron oxide, titanium dioxide, triphenylmethane dyes, azo dyes, quinoline dyes, indigotin dyes, carotenoids, to color the presentation forms, opacifiers such as titanium dioxide or talc, in order to increase the light transmittance and to save on the use of colorants.

The polymeric salts of active ingredients, according to certain embodiments of the invention, can to excellent effect be granulated and pressed to form tablets, which on account of their high solubility in aqueous media exhibit extremely rapid release of active ingredient. As a result of the improved solubility, a considerably improved bioavailability is achieved. The solubility is typically 0.05% to 5% (parts by weight of drug/parts by weight of water). Moreover, the bioavailability is much more reproducible—that is, there are fewer inter-individual fluctuations.

The salts of the invention can be formulated to give many different presentation forms, such as tablets, capsules, granules, powders, drug delivery systems, solutions, suppositories, transdermal systems, creams, gels, lotions, injection solutions, drops, juices, and syrups, for example.

Various embodiments of the invention are illustrated by the examples below:

### General Remarks:

The molecular weights were determined by gel permeation chromatography (GPC) (eluent: THF; standard: PMMA).

The acid numbers (mg KOH/g polymer) were determined in accordance with DIN 53402.

The glass transition temperatures were determined by means of differential scanning calorimetry (DSC). The sample was cooled to −30° C. and heated at a heating rate of 10 K/min. Evaluation was carried out on the second heating curve.

TMP×n EO means trimethylolpropane alkoxylated with n mol of ethylene oxide, where n can be an average (numerical average).

PEG 200 is a polyethylene glycol having an average molecular weight of 200 g/mol.

PEG 400 is a polyethylene glycol having an average molecular weight of 400 g/mol.

DI water: Fully demineralized (deionized) water

The samples obtained in examples 2 to 10 below were analyzed by XRD (X-ray diffractometry) and DSC (differential scanning calorimetry) for crystallinity or amorphousness, using the following instruments and conditions:

### XRD

Instrument: D 8 advance diffractometer with 9-position sample changer (Bruker/AXS)
Measurement mode: θ-θ geometry in reflection
Angle range 2 Theta: 2-80°
Step width: 0.02°
Measuring time per angular step: 4.8 s
Divergence slit: Gobel mirror with 0 4 mm inserted aperture
Antiscattering slit: Soller slit
Detector: Sol-X detector
Temperature: Room temperature
Generator setting: 40 kV/50 mA

### DSC

DSC Q 2000 from TA Instruments
Parameters:
Initial mass approximately 8.5 mg
Heating rate: 20 K/min

Release of active ingredient was determined in accordance with USP (paddle method) 2, 37° C., 50 rpm (BTWS 600, Pharmatest) in 0.1 molar hydrochloric acid for 2 h. The active ingredient released was detected by UV spectroscopy (Lambda-2, Perkin Elmer). The samples taken were diluted with methanol immediately after filtration, in order to prevent crystallization of the low-solubility active ingredient.

The twin-screw extruder used for preparing the formulations described in the examples below had a screw diameter of 16 mm and a length of 40D. The overall extruder was composed of 8 individually temperature-controllable barrel blocks. The first two barrels were set to temperatures of 20° C. and 70° C. respectively for improved intake of material. From the third barrel onward, a constant temperature was set, which is indicated separately in each case.

### Preparation of the Inventive Polyesters

### EXAMPLE A

A 500 ml round-bottom flask equipped with stirrer, internal thermometer, gas inlet tube, and descending condenser with collecting vessel was charged with 86.3 g (0.41 mol) of citric acid monohydrate and 138.9 g (1.31 mol) of diethylene glycol, and also with 0.1 g (255 ppm) of titanium(IV) tetrabutoxide. Under nitrogen blanketing, the mixture was heated to 130° C. and held at this temperature with stirring for 25 hours, during which water of reaction and water of crystallization that were given off were separated using the descending condenser. After an amount of water of 15 g (0.83 mol) had been separated off, the reaction mixture was cooled to 90° C. and admixed with a further 166.2 g (0.79 mol) of citric acid monohydrate. The reaction mixture was again heated to 130° C. and stirred for a further 25 hours, with a further 23 g (1.27 mol) of water being separated off. Thereafter the reaction was ended by cooling to room temperature.

The product was obtained in the form of a dark yellow, water-soluble resin. The following parameters were found:
Acid number=149 mg KOH/g polymer
Mₙ=700 g/mol, M_{w}=2920 g/mol

### EXAMPLE B

A 1000 ml round-bottom flask equipped with stirrer, internal thermometer, gas inlet tube, and descending condenser with collecting vessel was charged with 589.2 g (2.81 mol) of citric acid monohydrate and 613.6 g (3.07 mol) of PEG 200, and also with 0.5 g (400 ppm) of titanium(IV) tetrabutoxide. Under nitrogen blanketing, the mixture was heated to 130° C. and held at this temperature with stirring for 23 hours, during which water of reaction and water of crystallization that were given off were separated using the descending condenser. Thereafter the reaction was ended by cooling to room temperature.

The product was obtained in the form of a yellow, water-soluble resin. The following parameters were found:
Acid number=169 mg KOH/g polymer
Mₙ=1560 g/mol, M_{w}=12410 g/mol

### EXAMPLE C

A 500 ml round-bottom flask equipped with stirrer, internal thermometer, gas inlet tube, and descending condenser with collecting vessel was charged with 122.4 g (0.58 mol) of citric acid monohydrate and 127.6 g (0.64 mol) of PEG 200, and also with 0.1 g (400 ppm) of titanium(IV) tetrabutoxide. Under nitrogen blanketing, the mixture was heated to 130° C. and held at this temperature with stirring, during which water of reaction and water of crystallization that were given off were separated using the descending condenser. After a reaction time of 20 hours and an amount of water separated off of 18 g (1.0 mol), the reaction was ended by cooling to room temperature. The product was obtained in the form of a yellow-colored, water-soluble resin. The following parameters were found:
Acid number=167 mg KOH/g polymer
Mₙ=1030 g/mol, M_{w}=7000 g/mol

### EXAMPLE D

A 500 ml round-bottom flask equipped with stirrer, internal thermometer, gas inlet tube, and descending condenser with collecting vessel was charged with 95.0 g (0.45 mol) of citric acid monohydrate and 156.1 g (0.39 mol) of PEG 400, and also with 0.1 g (400 ppm) of titanium(IV) tetrabutoxide. Under nitrogen blanketing, the mixture was heated to 130° C. and held at this temperature with stirring for 7.5 hours, during which water of reaction and water of crystallization that were given off were separated using the descending condenser. Thereafter the reaction was ended by cooling to room temperature.

The product was obtained in the form of a colorless, water-soluble resin. The following parameters were found:
Acid number=168 mg KOH/g polymer
Mₙ=1020 g/mol, M_{w}=4300 g/mol

### EXAMPLE E

A 500 ml round-bottom flask equipped with stirrer, internal thermometer, gas inlet tube, and descending condenser with collecting vessel was charged with 97.6 g (0.47 mol) of citric acid monohydrate and 202.3 g (0.51 mol) of PEG 400, and also with 0.1 g (330 ppm) of titanium(IV) tetrabutoxide. Under nitrogen blanketing, the mixture was heated to 130° C. and held at this temperature with stirring for 24 hours, during which water of reaction and water of crystallization that were given off were separated using the descending condenser. Thereafter the reaction was ended by cooling to room temperature.

The product was obtained in the form of a yellow, water-soluble resin. The following parameters were found:
Acid number=138 mg KOH/g polymer
Mₙ=1440 g/mol, M_{w}=4310 g/mol

### EXAMPLE F

A 500 ml round-bottom flask equipped with stirrer, internal thermometer, gas inlet tube, and descending condenser with collecting vessel was charged with 75.4 g (0.36 mol) of citric acid monohydrate and 176.2 g (0.26 mol) of TMP×12 EO, and also with 0.1 g (400 ppm) of titanium(IV) tetrabutoxide. Under nitrogen blanketing, the mixture was heated to 130° C. and held at this temperature with stirring for 8.5 hours, during which water of reaction and water of crystallization that were given off were separated using the descending condenser. Thereafter the reaction was ended by cooling to room temperature.

The product was obtained in the form of a yellow, water-soluble resin. The following parameters were found:
Acid number=133 mg KOH/g polymer
Mₙ=3390 g/mol, M_{w}=14420 g/mol

### EXAMPLE G

A 500 ml round-bottom flask equipped with stirrer, internal thermometer, gas inlet tube, and descending condenser with collecting vessel was charged with 76.1 g (0.36 mol) of citric acid monohydrate and 176.5 g (0.26 mol) of TMP×12 EO, and also with 0.1 g (400 ppm) of titanium(IV) tetrabutoxide. Under nitrogen blanketing, the mixture was heated to 130° C. and held at this temperature with stirring for 4.5 hours, during which water of reaction and water of crystallization that were given off were separated using the descending condenser. Thereafter the reaction was ended by cooling to room temperature.

The product was obtained in the form of a colorless water-soluble resin. The following parameters were found:
Acid number=132 mg KOH/g polymer
Mₙ=3470 g/mol, M_{w}=18230 g/mol

### EXAMPLE H

A 500 ml round-bottom flask equipped with stirrer, internal thermometer, gas inlet tube, and descending condenser with collecting vessel was charged with 82.0 g (0.39 mol) of citric acid monohydrate and 168.8 g (0.25 mol) of TMP×12 EO, and also with 0.1 g (400 ppm) of titanium(IV) tetrabutoxide. Under nitrogen blanketing, the mixture was heated to 130° C. and held at this temperature with stirring for 3.5 hours, during which water of reaction and water of crystallization that were given off were separated using the descending condenser.

Thereafter the reaction was ended by cooling to room temperature.

The product was obtained in the form of a colorless resin. The following parameters were found:
Acid number=157 mg KOH/g polymer
Mₙ=2920 g/mol, M_{w}=11050 g/mol

### EXAMPLE I

A 2000 ml round-bottom flask equipped with stirrer, internal thermometer, gas inlet tube, and descending condenser with collecting vessel was charged with 393.6 g (1.87 mol) of citric acid monohydrate and 809.6 g (1.21 mol) of TMP×12 EO, and also with 0.35 g (300 ppm) of titanium(IV) tetrabutoxide. Under nitrogen blanketing, the mixture was heated to 130° C. and held at this temperature with stirring for 16 hours, during which water of reaction and water of crystallization that were given off were separated using the descending condenser. Thereafter the reaction was ended by cooling to room temperature.

The product was obtained in the form of a yellowish, water-soluble resin. The following parameters were found:
Acid number=152 mg KOH/g polymer
Mₙ=870 g/mol, M_{w}=12 900 g/mol
T_{g}=−30° C.

### EXAMPLEe J

A 500 ml round-bottom flask equipped with stirrer, internal thermometer, gas inlet tube, and descending condenser with collecting vessel was charged with 105.9 g (0.50 mol) of citric acid monohydrate and 211.1 g (0.32 mol) of TMP×12 EO, and also with 0.1 g (300 ppm) of titanium(IV) tetrabutoxide. Under nitrogen blanketing, the mixture was heated to 130° C. and held at this temperature with stirring for 11.5 hours, during which water of reaction and water of crystallization that were given off were separated using the descending condenser. Thereafter the reaction was ended by cooling to room temperature.

The product was obtained in the form of a yellow, water-soluble resin. The following parameters were found:
Acid number=159 mg KOH/g polymer
Mₙ=970 g/mol, M_{w}=12 270 g/mol

### COMPARATIVE EXAMPLE 1

A 500 ml round-bottom flask equipped with stirrer, internal thermometer, gas inlet tube, and descending condenser with collecting vessel was charged with 70.9 g (0.60 mol) of succinic acid, 155.0 g (0.50 mol) of TMP×5 EO, and 0.1 g of dibutyltin dilaurate. The reaction mixture was heated to 180° C. and was held under these conditions with stirring until the acid number of the reaction mixture had dropped to 54 mg KOH/g polymer. Then a further 67 g (0.22 mol) of TMP×5 EO were added and the reaction was continued at 180° C. until the reaction mixture had reached an acid number of 38 mg KOH/g polymer. The reaction was ended by cooling to room temperature.

The product was obtained in the form of a dark yellow, water-soluble resin. The following parameters were found:
Acid number=38 mg KOH/g polymer
Mₙ=170 g/mol, M_{w}=9380 g/mol

### COMPARATIVE EXAMPLE 2

A 500 ml round-bottom flask equipped with stirrer, internal thermometer, gas inlet tube, and descending condenser with collecting vessel was charged with 87.7 g (0.60 mol) of adipic acid, 155.0 g (0.50 mol) of TMP×5 EO, and 0.1 g of dibutyltin dilaurate. The reaction mixture was heated to 180° C. and was held under these conditions with stirring until the acid number of the reaction mixture had dropped to 62 mg KOH/g polymer. Then a further 81 g (0.26 mol) of TMP×5 EO were added and the reaction was continued at 180° C. until the reaction mixture had reached an acid number of 32 mg KOH/g polymer. The reaction was ended by cooling to room temperature.

The product was obtained in the form of a dark yellow, water-soluble resin. The following parameters were found:
Acid number=32 mg KOH/g polymer
Mₙ=170 g/mol, M_{w}=5530 g/mol

COMPARATIVE EXAMPLE 3

A 500 ml round-bottom flask equipped with stirrer, internal thermometer, gas inlet tube, and descending condenser with collecting vessel was charged with 212.6 g (1.80 mol) of succinic acid, 138.8 g (1.50 mol) of glycerol, and 0.1 g of dibutyltin dilaurate. The reaction mixture was heated to 150° C.-180° C. and was held under these conditions with stiffing until the acid number of the reaction mixture had dropped to 150 mg KOH/g polymer. Then a further 115 g (1.25 mol) of glycerol were added and the reaction was continued at 150° C.-180° C. until the reaction mixture had reached an acid number of 44 mg KOH/g polymer. The reaction was ended by cooling to room temperature.

The product was obtained in the form of a light yellow, water-soluble resin. The following parameters were found:
Acid number=44 mg KOH/g polymer
Mₙ=860 g/mol, M_{w}=3570 g/mol

### COMPARATIVE EXAMPLE 4

A 1000 ml round-bottom flask equipped with stirrer, internal thermometer, and reduced-pressure connection with downstream cold trap was charged with 87.5 g (0.60 mol) of adipic acid, 335 g (0.50 mol) of TMP 12 EO, and 0.2 g of 2% strength H₂SO₄. The reaction mixture was heated to 150° C., evacuated to below 200 mbar, and was held under these conditions with stiffing until the acid number of the reaction mixture had dropped to 50 mg KOH/g polymer. Then a further 251.5 g (0.38 mol) of TMP×12 EO were added and the reaction was continued under full reduced pressure and at 150-170° C. until the reaction mixture had reached an acid number of 20. The reaction was ended by cooling to room temperature.

The product was obtained in the form of a colorless, water-soluble resin.

The following parameters were found:
Acid number=19 mg KOH/g polymer
Mₙ=890 g/mol, M_{w}=3600 g/mol

### COMPARATIVE EXAMPLE 5

A 500 ml round-bottom flask equipped with stirrer, internal thermometer, and reduced-pressure connection with downstream cold trap was charged with 70.9 g (0.60 mol) of succinic acid, 333.4 g (0.50 mol) of TMP×12 EO, and 0.2 g of 2% strength H₂SO₄. The reaction mixture was heated to 150° C., evacuated to below 200 mbar, and was held under these conditions with stirring until the acid number of the reaction mixture had dropped to 30 mg KOH/g polymer. Then a further 88 g (0.13 mol) of TMP 12 EO were added and the reaction was continued under full reduced pressure and at 150° C. until the reaction mixture had reached an acid number of 20. The reaction was ended by cooling to room temperature.

The product was obtained in the form of a colorless, water-soluble resin. The following parameters were found:
Acid number=20 mg KOH/g polymer
Mₙ=1630 g/mol, M_{w}=12 990 g/mol

### Use Examples: Solubilizing Action

### EXAMPLE 1

To increase the solubility of the low-solubility active ingredients, 40 ml of a 15% polymer solution (in DI water) were prepared. This solution was admixed with an excess of low-solubillity active ingredient (cinnarizine, famotidine, loperamide, haloperidol, ketoconazolee or clotrimazole) and the mixture was stirred at room temperature for 72 hours. If the added active ingredient dissolved, further active ingredient was added, to supersaturation, followed by stirring for a further 72 hours. The resulting suspension was filtered through a 0.45 μm membrane filter and the dissolved fraction of active ingredient was determined by means of UV/Vis spectroscopy. The same method was also carried for the active ingredients alone, in order to determine the solubility of the pure active ingredient and to be able to determine the improvement through salt formation. For comparison, the solubility in 0.1 normal HCl as well was ascertained, representing the solubility of the hydrochloride salt of the corresponding base.

The results are set out in the table below.

| | | Saturation in 15% strength polymer solution | | | | | |
|---|---|---|---|---|---|---|---|
| | | [g/100 mL] | | | | | |
| | | Cinna- | Famo- | Loper- | Halo- | Keto- | Clotrim- |
| Polymer | Composition | rizine | tidine | amide | peridol | conazole | azole |
| — | DI water | <0.001 | 0.100 | 0.007 | | | |
| — | 0.1N HCl | 0.174 | 3.210 | 0.020 | | | |
| — | Cremophor EL | 0.11 | 0.46 | 0.01 | | | |
| | for comparison | | | | | | |
| — | Solutol HS 15 | 0.06 | 0.41 | 0.06 | | | |
| | for comparison | | | | | | |
| A | CA:DEG | 0.76 | 7.39 | 4.34 | | | |
| C | CA:PEG200 | 1.58 | 13.39 | 2.37 | | | |
| B | CA:PEG200 | 1.35 | | 4.49 | | | |
| C | CA:PEG200 | 1.40 | 11.65 | 2.34 | | | |
| D | CA:PEG400 | 1.41 | 13.39 | 1.67 | | | |
| E | CA:PEG400 | 1.30 | 12.33 | 1.64 | | | |
| F | CA:TMP12EO | 2.06 | 10.23 | 2.84 | | | |
| G | CA:TMP12EO | 4.60 | 9.17 | 2.89 | 3.45 | 5.38 | 0.67 |
| H | CA:TMP12EO | 2.53 | 10.25 | 2.70 | 2.77 | 6.16 | 0.84 |
| I | CA:TMP12EO | 3.98 | 9.40 | 2.71 | | | |
| J | CA:TMP12EO | 4.88 | 9.89 | 2.90 | | | |

Comparative examples

| | | | | |
|---|---|---|---|---|
| 1 | SA:Gly5EO | 0.26 | 4.13 | 1.44 |
| 2 | ADA:Gly5EO | 0.26 | 3.72 | 1.55 |
| 3 | SA:Gly | 0.32 | 4.47 | 2.18 |
| 4 | ADA:TMP12EO | 0.16 | 2.55 | 0.93 |
| 5 | SA:TMP12EO | 0.24 | 2.63 | 1.23 |

### EXAMPLE 2

Preparation of a Salt of Loperamide and Polymer B by Extrusion
4500 g of polymer B and 500 g of loperamide were weighed out into a vessel and mixed in a Turbula T10B mixer for 10 minutes.

The mixture was extruded with the following parameters:
Zone temperature, barrel 1: 20° C.; barrel 2: 40° C.
Zone temperature, barrel 3 onward: 110° C.
Screw speed 200 rpm
Throughput: 500 g/h
Die diameter 3 mm

The comminuted extrudates were analyzed by XRD and by DSC, and found to be amorphous. After 40 minutes in DI water, 90% of active ingredient had been released.

### EXAMPLE 3

Preparation of a Salt of Loperamide and Polymer E by Extrusion
4500 g of polymer E and 500 g of loperamide were weighed out into a vessel and mixed in a Turbula T10B mixer for 10 minutes.
The mixture was extruded with the following parameters:
Zone temperature, barrel 1: 20° C.; barrel 2: 40° C.
Zone temperature, barrel 3 onward: 140° C.
Screw speed 200 rpm
Throughput: 500 g/h
Die diameter 3 mm

The comminuted extrudates were analyzed by XRD and by DSC, and found to be amorphous. After 60 minutes in DI water, 100% of active ingredient had been released.

### EXAMPLE 4

Preparation of a Salt of Haloperidol and Polymer G by Extrusion
4500 g of polymer G and 500 g of haloperidol were weighed out into a vessel and mixed in a Turbula T10B mixer for 10 minutes.
The mixture was extruded with the following parameters:
Zone temperature, barrel 1: 20° C.; barrel 2: 40° C.
Zone temperature, barrel 3 onward: 135° C.
Screw speed 200 rpm
Throughput: 500 g/h
Die diameter 3 mm

The comminuted extrudates were analyzed by XRD and by DSC, and found to be amorphous. After 37 minutes in DI water, 98% of active ingredient had been released.

### EXAMPLE 5

Preparation of a Salt of Famotidine and Polymer D by Extrusion
4500 g of polymer D and 500 g of famotidine were weighed out into a vessel and mixed in a Turbula T10B mixer for 10 minutes.

The mixture was extruded with the following parameters:
Zone temperature, barrel 1: 20° C.; barrel 2: 40° C.
Zone temperature, barrel 3 onward: 138° C.
Screw speed 200 rpm
Throughput: 500 g/h
Die diameter 3 mm

The comminuted extrudates were analyzed by XRD and by DSC, and found to be amorphous. After 30 minutes in DI water, 100% of active ingredient had been released.

### EXAMPLE 6

Preparation of a Salt of Cinnarizine and Polymer G by Extrusion
4500 g of polymer G and 500 g of cinnarizine were weighed out into a vessel and mixed in a Turbula T10B mixer for 10 minutes.
The mixture was extruded with the following parameters:
Zone temperature, barrel 1: 20° C.; barrel 2: 40° C.
Zone temperature, barrel 3 onward: 110° C.
Screw speed 200 rpm
Throughput: 500 g/h
Die diameter 3 mm

The comminuted extrudates were analyzed by XRD and by DSC, and found to be amorphous. After 40 minutes in DI water, 90% of active ingredient had been released.

### EXAMPLE 7

Preparation of a Salt of Ketoconazole and Polymer H by Dissolution in an Organic Solvent and Subsequent Evaporation

5 g of ketoconazole were dissolved in 150 g of a 30% strength solution of polymer H in ethanol with stirring for 2 hours. This solution was evaporated to dryness on a rotary evaporator at 80° C. The X-ray-amorphous solid obtained was subsequently ground to a powder.

Product Properties:
Residual moisture content: 1.4% (w/w)
Solubility of the polymeric ketoconazole salt in water,
measured as dissolved ketoconazole: 7 g/100 mL

### EXAMPLE 8

Preparation of a Salt of Famotidine and Polymer E by Dissolution in an Organic Solvent and Subsequent Evaporation

10 g of famotidine were dissolved in 150 g of a 30% strength solution of polymer E in ethanol with stirring for 2 hours. This solution was evaporated to dryness on a rotary evaporator at 80° C. The solid obtained was subsequently comminuted.

Product Properties:
Residual moisture content: 1.6% (w/w)
Solubility of the polymeric famotidine salt in water,
measured as dissolved famotidine: 13 g/100 mL

### EXAMPLE 9

Preparation of a salt of loperamide and polymer G by extrusion
4500 g of polymer G and 500 g of loperamide were weighed out into a vessel and mixed in a Turbula T10B mixer for 10 minutes.

The mixture was extruded with the following parameters:
Zone temperature, barrek 1: 20° C.; barrel 2: 40° C.
Zone temperature, barrel 3 onward: 120° C.
Screw speed 200 rpm
Throughput: 500 g/h
Die diameter 3 mm

The comminuted extrudates were analyzed by XRD and by DSC, and found to be amorphous. After 1 hour in DI water, 95% of active ingredient had been released.

### EXAMPLE 10

4500 g of polymer G and 500 g of haloperidol were weighed out into a vessel and mixed in a Turbula T10B mixer for 10 minutes.

The mixture was extruded with the following parameters:
Zone temperature, barrel 1: 20° C.; barrel 2: 40° C.
Zone temperature, barrel 3 onward: 130° C.
Screw speed 200 rpm
Throughput: 500 g/h
Die diameter 3 mm

The comminuted extrudates were analyzed by XRD and by DSC, and found to be amorphous. After 40 minutes in DI water, 99% of active ingredient had been released.

### EXAMPLE 11

Production of Tablets with a Polymeric Salt of Ketoconazole and Polymer H

17 g of polymeric ketoconazole salt from example 7 were mixed with 150 g of microcrystalline cellulose, 118 g of dicalcium phosphate, 12 g of Kollidon CL-F, and 3 g of magnesium stearate, and the mixture was pressed on an eccentric tableting press to give tablets having the following properties:
Diameter: 10 mm
Weight: 300 mg
Fracture strength: 78 N
Disintegration: 29 s
Active ingredient release in DI water: 99% after 15 minutes

### EXAMPLE 12

Production of Tablets with a Polymeric Salt of Haloperidol and Polymer G
65 g of polymeric haloperidol salt from example 4 were mixed with 110 g of microcrystalline cellulose, 110 g of dicalcium phosphate, 12 g of Kollidon CL-F, and 3 g of magnesium stearate, and the mixture was pressed on a rotary tableting press to give tablets having the following properties:
Diameter: 10 mm
Weight: 300 mg
Fracture strength: 80 N
Disintegration: 58 s
Active ingredient release in water: 87% after 15 minutes

### EXAMPLE 13

Preparation of a Polymeric Salt by Means of Film Extrusion
1200 g of polymer D and 400 g of clotrimazole were weighed out into a vessel and mixed in a Turbula T10B mixer for 10 minutes.

The mixture was extruded with the following parameters:
Zone temperature, barrel 1: 20° C.; barrel 2: 40° C.
Zone temperature, barrel 3 onward: 140° C.
Screw speed 200 rpm
Throughput: 300 g/h

The resulting film had a thickness of 120 μm and an elongation at break of 3.7%. The dissolution time in DI water was 20 seconds.

### EXAMPLE 14

Preparation of a Polymeric Salt of Ketoconazole and Polymer I by means of Film Extrusion

1200 g of polymer I and 400 g of ketoconazole were weighed out into a vessel and mixed in a Turbula T10B mixer for 10 minutes.

The mixture was extruded with the following parameters:
Zone temperature, barre 1: 20° C.; barrel 2: 40° C.
Zone temperature, barrel 3 onward: 135° C.
Screw speed 200 rpm
Throughput: 200 g/h

The resulting film had a thickness of 168 μm and an elongation at break of 3.8%. The dissolution time in DI water was 38 seconds.

### EXAMPLE 15

Preparation of a Polymeric Salt of Ketoconazole and Polymer I by Evaporation

200 g of polymer I and 50 g of ketoconazole were dissolved in a methanol/water mixture. The solution was poured onto a rubber plate and dried at 40° C. under reduced pressure.

The resulting film had a thickness of 108 μm and an elongation at break of 5.8%. The dissolution time in DI water was 18 seconds.

### EXAMPLE 16

Preparation of a Polymeric Salt of Clotrimazole and Polymer G as a Coating for Carrier Pellets (Nonpareils)

The carrier pellets were placed in a fluidized-bed apparatus and were sprayed with an ethanolic solution of polymer and active ingredient.

| Composition | Amount |
|---|---|
| Polymer G | 400 g |
| Clotrimazole | 100 g |
| Sucrose pellets | 1000 g |

Glatt GPCG 3.1 fluidized-bed granulator:

| Operating parameters | Values |
|---|---|
| Volume flow [m³/h] | 140 |
| Feed air temperature [° C.] | 65 |
| Spray air pressure [MPa] | 0.40 |

XRD analysis indicated no crystalline fractions of active ingredient.

The release of the active ingredient from 400 mg of pellets was carried out in a USP apparatus 2 in 700 ml of DI water. After 60 minutes, 90% of the active ingredient had been released.

### EXAMPLE 17

Preparation of a polymeric salt of cinnarizine and polymer J as a coating for carrier pellets (nonpareils)

The carrier pellets were placed in a fluidized-bed apparatus and were sprayed with an ethanolic solution of polymer and active ingredient.

| Composition | Amount |
|---|---|
| Polymer J | 1600 g |
| Cinnarizine | 400 g |
| Sucrose pellets | 1000 g |

Glatt GPCG 3.1 fluidized-bed granulator:

| Operating parameters | Values |
|---|---|
| Volume flow [m³/h] | 140 |
| Feed air temperature [° C.] | 60 |
| Spray air pressure [bar] | 4.0 |

XRD analysis indicated no crystalline fractions of active ingredient.

The release of the active ingredient from 400 mg of pellets was carried out in a USP apparatus 2 in 700 ml of DI water. After 60 minutes, 90% of the active ingredient had been released.

What is claimed is:

1. A branched polyester obtained by polycondensation of citric acid with at least one polyalcohol having at least two hydroxyl groups, wherein the molar ratio of citric acid to polyalcohol is 2.4:1 to 1:3.

2. The polyester of claim 1, wherein the molar ratio of citric acid to polyalcohol is 2.4:1 to 1:2.4.

3. The polyester of claim 1, wherein the molar ratio of citric acid to polyalcohol is 2:1 to 1:2.

4. The polyester of claim 1, wherein the branched polyester is obtained by polycondensation of citric acid and at least one other polycarboxylic acid with at least one polyalcohol having at least two hydroxyl groups.

5. The polyester of claim 1, wherein the polyalcohol is a reaction product of compounds having at least two hydroxyl groups and ethylene oxide or propylene oxide, or with mixtures of ethylene oxide and propylene oxide, or mixtures of such reaction products.

6. The polyester of claim 1, wherein the polyalcohol is selected from the group consisting of glycerol, diglycerol, triglycerol, trimethylolethane, trimethylolpropane, di(trimethylolpropane), 1,2,4-butanetriol, 1,2,6-hexanetriol, pentaerythritol, reaction products thereof with ethylene oxide or propylene oxide or with mixtures of ethylene oxide and propylene oxide, and combinations thereof.

7. The polyester of claim 1, wherein the polyalcohol is a polyethylene glycol having a molecular weight of 150 to 1500 g/mol.

8. The polyester of claim 4, wherein the molar fraction of the at least one other polycarboxylic acid components is less than the molar fraction of citric acid.

9. The polyester of claim 1, wherein the polyester has a molecular weight Mₙ of 500 to 5000 g/mol.

10. The polyester of claim 1, wherein the polyester has a molecular weight M_{w} of 1500 to 50,000 g/mol.

11. The polyester of claim 1, wherein the polyester has an acid number of 60 to 600 mg KOH/g polymer.

12. The polyester of claim 6, wherein the polyalcohol is selected from the group consisting of trimethylolethane, trimethylolpropane, di(trimethylolpropane), 1,2,4-butanetriol, 1,2,6-hexanetriol, pentaerythritol, reaction products thereof with ethylene oxide or propylene oxide or with mixtures of ethylene oxide and propylene oxide, and combinations thereof.

13. The polyester of claim 11, wherein the polyester has an acid number in the range of 80 to 500 mg KOH/g polymer.

14. The polyester of claim 13, wherein the polyester has an acid number in the range of 100 to 400 mg/KOH/g polymer.

15. The polyester of claim 14, wherein the polyester has an acid number in the range of from 132 to 400 mg KOH/g polymer.

16. The polyester of claim 1, wherein the polyester is non-crosslinked.

17. The polyester of claim 1, wherein the polyester has a degree of crosslinking of less than 15% by weight.

18. The polyester of claim 17, wherein the degree of crosslinking is less than 10% by weight.

19. A branched polyester obtained by polycondensation of citric acid with at least one polyalcohol having at least two hydroxyl groups, and a further polycarboxylic acid component, wherein the molar ratio of citric acid to polyalcohol is 2.4:1 to 1:3.

20. The polyester of claim 19, wherein the polyalcohol is selected from the group consisting of trimethylolethane, trimethylolpropane, di(trimethylolpropane), 1,2,4-butanetriol, 1,2,6-hexanetriol, pentaerythritol, reaction products thereof with ethylene oxide or propylene oxide or with mixtures of ethylene oxide and propylene oxide, and combinations thereof.
